(19) United States
(12) Patent Application Publication
(10) Pub. No.: US 2024/0098559 A1
(43) Pub. Date: Mar. 21, 2024

(54) UPLINK LATENCY REDUCTION IN FDD-TDD CARRIER AGGREGATION NETWORKS

(71) Applicant: Apple Inc., Cupertino, CA (US)

(72) Inventors: Murali Narasimha, San Ramon, CA (US); Lakshmi Iyer, Cupertino, CA (US); Mariam Motamed, Redwood City, CA (US); Neha Goel, Herndon, VA (US); Sreevalsan Vallath, Dublin, CA (US)

(21) Appl. No.: 18/369,085

(22) Filed: Sep. 15, 2023

Related U.S. Application Data
(63) Continuation of application No. 18/368,926, filed on Sep. 15, 2023.
(60) Provisional application No. 63/407,450, filed on Sep. 16, 2022.

(51) Int. Cl. H04W 28/02; H04L 5/14; H04W 72/0453; H04W 72/232

(52) U.S. Cl. CPC H04W 28/0278; H04L 5/14; H04W 28/0236; H04W 72/0453; H04W 72/232

(57) ABSTRACT

Systems and methods are for configuring a periodic uplink (UL) resource on a first carrier of a user equipment (UE); transmitting a buffer status report (BSR) on the first carrier using the configured UL resource, the buffer status report indicating a request for transmission resources on a second carrier; receiving an UL grant for data transmission on the second carrier, the UL grant indicating transmission resources on the second carrier; and transmitting a user data packet on the second carrier using the transmission resources indicated in the UL grant.

### CLAIM OF PRIORITY

This application is a continuation of U.S. patent application Ser. No. 18/368,926, filed on Sep. 15, 2023, which claims priority under 35 U.S.C. § 119(e) to U.S. Patent Application Ser. No. 63/407,450, filed on Sep. 16, 2022, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

Fifth Generation (5G) new radio (NR) networks are configured to use carrier aggregation (CA) that enables use of multiple sub-six gigahertz spectrum channels simultaneously to increase the bandwidth and reduce latencies in the network. To further enhance the performance of 5G networks, the network is configured for time division duplex (TDD) and frequency division duplex (FDD) carrier aggregation. Generally, FDD uses separate frequencies (paired spectrum) for the uplink (UL) and the downlink (DL) connections. Generally, TDD uses a single frequency for both UL and DL connections. FDD and TDD transmit at different times. TDD carrier aggregation is suitable when a paired spectrum is not available.

Each of FDD based connections and TDD based connections provide different advantages. In general, the FDD carrier provides better coverage relative to the TDD carrier, and the TDD carrier provides better capacity relative to the FDD carrier. The FDD carrier uses a limited spectrum, while the TDD carrier uses a relatively larger portion of the spectrum, but the portion of the spectrum is shared between the uplink connection and downlink connection. Additionally, the FDD carrier is relatively better than the TDD carrier for low latency applications because for FDD connections, the UL resources are available continuously. However, data rates for the FDD carrier are relatively low because the available bandwidth (BW) is small when compared to the TDD carrier. In contrast, TDD based connections have a larger BW but do not have continuously available UL slots. TDD carriers therefore can transport larger packets than FDD carriers, but with overall greater latency.

Many applications have higher DL data rate requirements than UL data rate requirements. Many applications also have shorter latency requirements for DL connections than for UL connections. However, in some implementations, applications can require a low latency for UL traffic combined with a moderate to high UL data rate.

Typical 5G deployments can use a lower frequency FDD spectrum with higher frequency TDD spectrum. The available FDD spectrum is limited for a given operator (e.g., between 10-20 megahertz). In contrast, the TDD spectrum is wider (e.g., more than 50 MHz). Given that the lower frequencies provide wider coverage, operators can rely on the FDD carries as anchor carriers and the TDD carriers to transfer larger volumes of data. The TDD carriers are configured for mostly DL connections such that a majority (e.g., ˜80%) of the time-frequency resources are used for DL traffic. While this configuration works well for DL traffic, this configuration results in an issue for UL traffic. The issue is that the relatively narrow bandwidth of the FDD carrier, combined with a requirement to share spectrum with a relatively large number of devices (e.g., user equipment UEs) in the coverage area results in a relatively low data rate for UL connections on the FDD carrier. On the other hand, while the TDD carrier can support higher instantaneous UL data rates, the availability of UL transmission opportunities is relatively infrequent compared to FDD UL opportunities, resulting in relatively high UL latencies.

To overcome these issues, the systems and processes described herein are configured for reducing latency in FDD and TDD CA scenarios. To reduce latencies, the following general procedure is performed. The network (e.g., a base station, next generation node gNB, etc.) is configured to communicate with the UE using a configured grant (CG) for buffer status report (BSR) transmissions. The BSR indicates how much data is buffered at the UE for transmission (e.g., for UL transmission). In a conventional connection, the UE sends a scheduling request to the base station. This is a request from the UE for the base station to allocate slot(s) for transmitting the BSR. The base station responds (e.g., using a physical downlink control channel PDCCH) by providing indication to the UE of additional UL grants that specify which resources are available to the UE for sending the data buffered at the UE (indicated in the BSR). The UE uses the allocated UL grant for transmitting the BSR information to the base station. Based on BSR, NW allocates further UL grants for sending the data.

The processes and systems described herein use a CG for BSR transmissions. The CG specifies a pre-allocated UL resource that is available to the UE for BSR transmissions. The CG is provided to the UE with sufficient frequency to be able to transmit a BSR directly without going through the SR transmission step. This reduces some latency by eliminating the SR transmission.

Additionally, the CG for BSR transmission is provided on the FDD carrier. In response to the BSR, the network allocates a UL grant on the TDD carrier. The approach of transmitting the BSR on FDD and the UL data on TDD has approximately the same latency as transmitting the BSR and UL data on FDD, but also allows larger grants to be provided for the UL data because the TDD carrier has access to larger bandwidths.

The systems and methods described herein provide one or more of the following advantages. These processes and systems can provide lower latencies and more flexible transmissions for applications, such as applications for augmented reality devices, using multiple traffic streams that each have data arriving at different periodicities. The systems and method described herein can satisfy the rigid latency and reliability requirements for each traffic stream, and also provide medium to high data rates required by these applications. These systems and methods provide, for the UL in particular, relatively low latencies when a UE is coverage-limited. Given the combination of data rates and reliability requirements, and the lower maximum transmit power of the UE in comparison with the base station (gNB), the systems and processes herein enable the latency budget to be met in significant portions of the coverage area of a cell. Typically, for such applications, the periodicity of the traffic is typically such that the transmit buffer is empty when the data becomes available. Thus there is no ongoing data transmission and the UE requests a resource allocation to transmit the new data.

One or more of these advantages are enabled by one or more of the following embodiments described in the examples section below and throughout the following description.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, in accordance with some embodiments.

FIG. 2 shows a diagram of configurations for carrier aggregation of the FDD and TDD carriers.

FIG. 3 shows a diagram of configurations for carrier aggregation of the FDD and TDD carriers.

FIG. 4 shows a process for UL latency reduction in FDD-TDD carrier aggregation networks.

FIG. 5 shows a process for indicating a buffer status of a UE in a FDD-TDD carrier aggregation network.

FIG. 6 shows a process for UL latency reduction in FDD-TDD carrier aggregation networks.

FIG. 7 illustrates a user equipment (UE), in accordance with some embodiments.

FIG. 8 illustrates an access node, in accordance with some embodiments.

### DETAILED DESCRIPTION

Fifth Generation (5G) new radio (NR) networks are configured to use carrier aggregation (CA) that enables use of time division duplex (TDD) and frequency division duplex (FDD) carrier aggregation. Generally, FDD uses separate frequencies for the uplink (UL) and the downlink (DL) connections. Generally, TDD uses a single frequency for both UL and DL connections. In general, the FDD carrier provides better coverage relative to the TDD carrier, and the TDD carrier provides better capacity relative to the FDD carrier. The FDD carrier is relatively better than the TDD carrier for low latency applications because for FDD connections, the UL resources are available continuously. However, data rates for the FDD carrier are relatively low because the available bandwidth (BW) is small when compared to the TDD carrier.

The processes and systems described herein use a configured grant (CG) for buffer status report (BSR) transmissions. The CG specifies a pre-allocated UL resource that is available to a user equipment (UE) for BSR transmission. The CG is provided to the UE with sufficient frequency to be able to transmit a BSR directly without going through the SR transmission step and reduce latency for data UL transmission by eliminating the SR transmission. Additionally, the CG for BSR transmission is provided on the FDD carrier. The BSR includes data specifying which carrier (FDD or TDD) on which the UE would like to receive an UL grant for UL data transmission. For larger payloads, the TDD carrier is specified. In response to the BSR, the network allocates a UL grant on the TDD carrier. Transmitting the BSR on FDD and the UL data on TDD has approximately the same latency as transmitting the BSR and UL data on FDD, but also allows larger grants to be provided for the UL data because the TDD carrier has access to larger bandwidths. Therefore, the UL grant is transmitted using the TDD carrier instead of FDD carrier to enable more data transmission. The BSR is sent on FDD carrier for a reduced latency, because UL slots continuously available on FDD (e.g., every slot is UL slot).

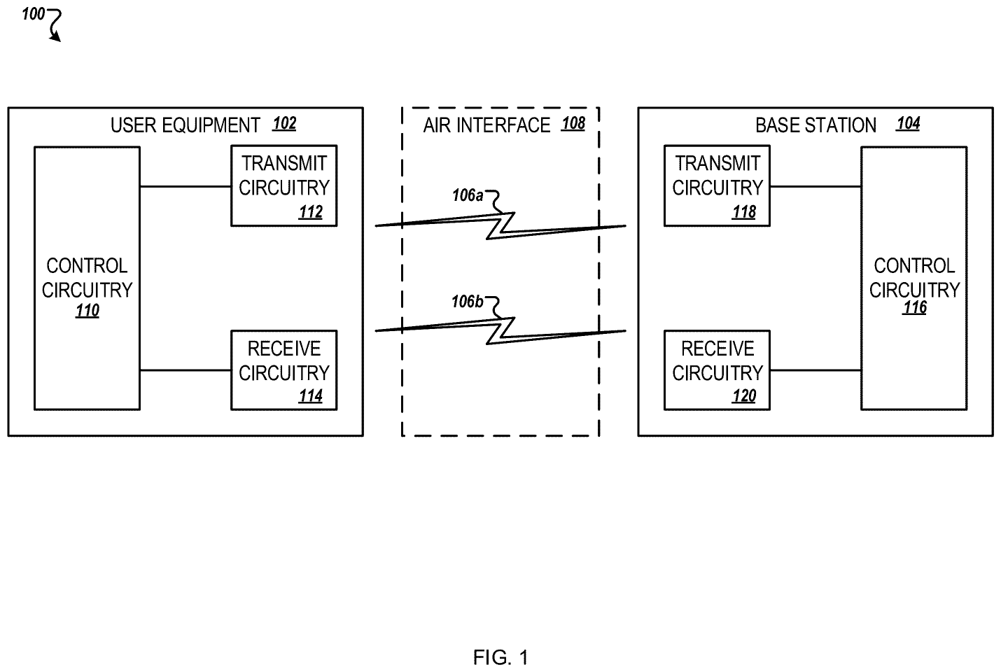

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels includes of a plurality of downlink sub-frames. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

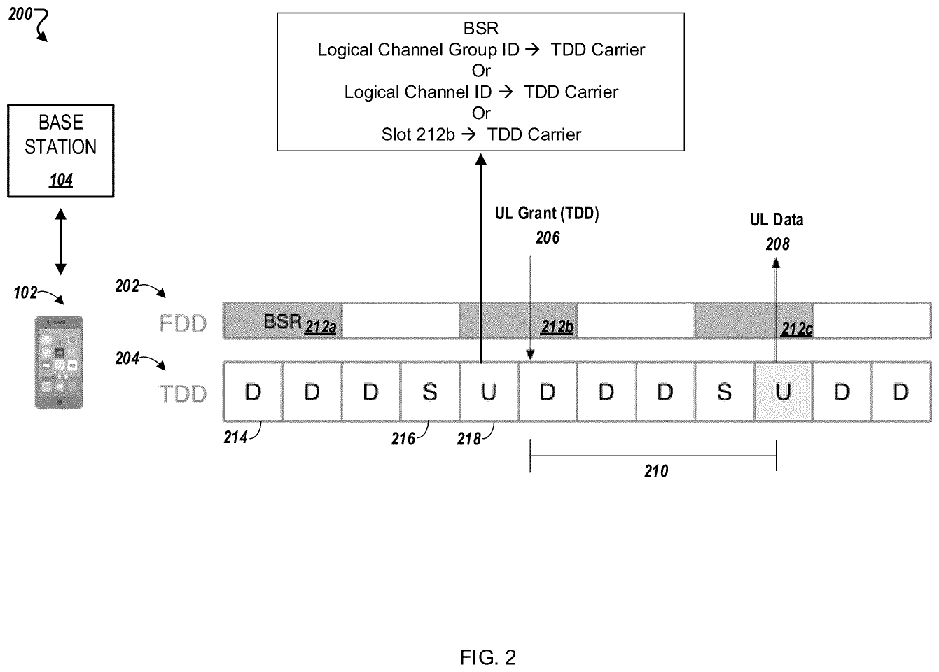

FIG. 2 shows a diagram of a transmission space 200 for a UE (e.g., UE 102 of FIG. 1). The transmission space 200 has an FDD carrier 202 and a TDD carrier 204. The FDD carrier has a configured grant allocated for BSR at instances 212a, 212b, 212c, and so forth. The CG occurs frequently enough that the BSR can be transmitted without the need for a SR transmission from the UE 102. The TDD carrier 204 has slots for downlink 214, labeled “D,” switching 216, labeled “S,” and uplink 218, labeled “U.” In the example of the transmission space 200, a UL grant 206 is received at the UE 102 from the network (e.g., a gNB or base station). The UE sends UL data 208 back to the network at the next UL slot. A latency is shown by period 210. In an example, the slots for the FDD are 1 ms in length, while the slots of the TDD are 0.5 ms in length. The subcarrier spacing (SCS) used on the carrier governs the length of the slots.

Generally, the network 104 provides a configured grant (CG) configuration on the FDD carrier 202, with a small periodicity shown by instances of 212a-c. For example, the periodicity can include a CG resource every slot or every other slot. In the example transmission space 200, the periodicity is every other slot for the FDD. The CG accommodates a relatively small payload, which is adequate to reliably carry a buffer status report (BSR).

When data are available for transmission, the UE transmits a BSR using the next available CG occasion (e.g., 212a, 212b, etc.). The BSR includes data that indicates the carrier on which the UE 102 would like to receive an UL grant for UL data transmission. For larger payloads, the UE indicates in the BSR that the UL grant should be on the TDD carrier. In some implementations, as subsequently described, the UE can specify that the FDD is used (e.g., for smaller payloads). Therefore, the BSR can be used to dynamically set the carrier. Different signaling methods of specifying the carrier are subsequently described.

The UE 102 receives the UL grant 206 on one of the configured TDD carriers 204 and transmits the user data on that carrier. The UL grant 206 is received at the next DL slot 214. A latency 210 is introduced, as the UE 102 sends the data 208 at the next available UL slot 218.

The UE 102 is configured to indicate whether the network 104 should configure the UL grant for the FDD carrier 202 or the TDD carrier 204. The UE 102 can use different signaling methods to specify the selected carrier to the network 104. The signaling method generally is preconfigured.

In a first example, a logical channel group is signaled in the BSR. The logical channel group (LCG) is an indication to the network 104 that UL grant 206 should be, for example, the TDD carrier 204. In some implementations, there can be a pre-defined mapping of the LCG of the logical channel carrying the data to a specific carrier (e.g., FDD 202 or TDD 204). The LCG is signaled in the BSR.

In a second example, a special logical channel ID, used in MAC layer signaling, indicates the selected carrier type for the UL grant 206. In some implementations, a reserved LCD is used to indicate a BSR for a particular carrier (e.g., TDD 204 or FDD 202). For example, if the UE 102 is configured with carrier 1 (FDD), carrier 2 (TDD) and carrier 3 (TDD), UL LCID 35 can be used to indicate BSR requesting UL grant on carrier 2 and UL LCD 36 can be used to indicate BSR requesting UL grant on carrier 3. Other LCIDs can be reserved for indicating the carrier type.

In a third example, a timing of the BSR, such as the particular slot in which the BSR is sent to the network 104 from the UE 102, indicates to the network which carrier is being requested for the UL grant 206. In other words, the slot in which the BSR is sent can indicate the carrier on which the UL grant is requested. For example, if the BSR is sent in odd numbered slot of a radio frame, this can be understood by the network as being a request for UL data on carrier 2. If the BSR is sent in an even numbered slot of a radio frame, this can be understood by the network as representing a request for UL data on carrier 3.

Given that the BSR indicates a specific carrier for UL data 208 transmission, the UE 102 can use additional functionality to reduce power consumption. The UE 102 can use the BSR to indicate that the UE will not monitor PDCCH on any carrier other than the TDD carrier for some duration. This can be performed in addition to indicating a carrier for UL data 208 transmission. The network 104 can deactivate the other carriers (e.g., FDD 202) in response to such a BSR.

The network (e.g., a base station 104) can impose additional restrictions on the UE 102 to ensure that only data for the specific logical channel is transmitted on the TDD carrier 204. The network configures a mapping of logical channels to serving cells to ensure that only the data for the specific logical channel is transmitted on the specified carrier.

The UE 102 or network 104 or both can be configured for selective mapping of data to TDD or FDD carriers. For example, the mapping of data to a carrier can be based on the type of data being transmitted. The data type can be mapped to a specific carrier because, for example, some data flows have smaller packets (e.g., audio packets). In another example, some data types have relatively higher reliability requirements or relatively lower latency requirements. In contrast, other data flows may have larger packets with relatively lower reliability requirements. The resources for UL data transmission are adjustable based on the type and size of the buffered data stored by the UE 102. For example, the UE 102 can be configured with a buffer size (e.g., data volume or data amount) threshold. Generally, the buffer size refers to an amount of data in the buffer. If the buffered data size is larger than the threshold, the UE 102 transmits a BSR indicating a need for UL resources on the TDD carrier 204. Otherwise, the UE 102 transmits a BSR indicating a need for UL resource on the FDD carrier 202. For smaller packet sizes, transmission on the FDD carrier 202 can enable better uplink coverage and lower latencies. Generally, the UE 102 signaling can be is configured such that the network 104 determines the data type (e.g., that the data is audio) based on one of the signaling options previously described (e.g., slot, timing, LCD, or logical channel group ID). When the data type is decoded, the network 104 provides a UL grant 206 on the mapped carrier (e.g., the FDD carrier 204 for audio packets). Else, the network 104 provides the UL grant 206 on the TDD carrier.

The UE 102 signaling can be used to optimizing UL grant 206 sizes from the network 104. Generally, the buffer sizes indicated by the BSR are defined in tables in 3GPP TS 38.321 § 6.1.3.1. These values have a relatively large granularity. For example, the buffer size is signaled using 8 bits (e.g., for a long BSR). Each 8 bit value indicates a predefined buffer size. The buffer sizes indicated are generally approximate. For example, the value 164 indicates a buffer size of up to 301579 bits, while a value of 165 indicates a buffer size of up to 321155 (a change of about 20 k bits). Various applications may require more precision in defining the ranges of the buffer size to optimize UL grants.

Generally, the packet sizes for transmitting data are fixed and periodic. The approximate ranges of buffer size are known to the network 104. Additionally, when data are in the buffer for more than a threshold amount of time, the data are discarded. In some implementations, when data are available, the buffer sizes can only be from a relatively small set of values based on possible combinations of packets of different streams that are available. However, this may not be true when the UE 102 is operating as a hotspot such that the data originates on a different device and is transferred to the UE via a WiFi link. In such cases, the UL packet arrivals at the UE 102 are subject to variable delays. Regardless, when the network 104 determines the buffer size, the network is able to assign resources in the UL grant 206 more efficiently and can make the data transmission more reliable.

The UE 102 is configured to signal buffer sizes as described below to increase precision of the reported buffer size. When a session with data meeting the above criteria is initiated, the UE 102 signals to the base station 104 data specifying a mapping of BSR code points (e.g., the values 1 to 128) to possible buffer sizes that are available. The mapping overrides the standardized buffer sizes for the duration of the session or until an alternate buffer size mapping is signaled by the UE 102 to the network 104. When data arrives, the UE 102 signals, in the BSR, the code point corresponding to the buffered data size. In response, the base station 104 allocates a UL grant 206 according to the mapped buffer size. Because the mapped size is almost always smaller than the standardized buffer size corresponding to the same code point, the base station 104 is able to configure modulation and coding such that each UL packet is received at the UE 102 more reliably. The buffer sizes are therefore redefined to more granular definitions that are centered on likely use cases.

Table 1 shows estimated latencies (in milliseconds (ms)) for the cases where (a) BSR and UL data are both transmitted on the FDD carrier 202, (b) BSR and UL data are both transmitted on the TDD carrier 204, and (c) BSR is transmitted on the FDD carrier 202 and UL data is transmitted on the TDD carrier 204. Transmitting the BSR on FDD and the UL data on TDD has approximately the same latency as transmitting the BSR and UL data on FDD 202, but with the advantage that larger grants can be provided for the UL data (e.g., due to the larger TDD bandwidths). There are 14 symbols in a slot. A slot in 15 kilohertz (kHz) SCS carrier is 1 ms long and a slot in a 30 kHz SCS carrier is 0.5 ms long. This results in each symbol being 1/14 ms or 1/28 ms, respectively.

TABLE 1
Latency Estimates for Various Carrier Configurations

| | | | | BSR on FDD |
|---|---|---|---|---|
| | | BSR and UL | BSR and UL | and UL data |
| | | data on FDD | data on TDD | on TDD |
| | | (Symbols) | (Symbols) | (Symbols) |
| BSR | UE processing delay | 5 | 6 | 5 |
| | Frame alignment within slot | 14 | 14 | 14 |
| | (worst case) | | | |
| | Wait for slot | 0 | 70 | 0 |
| | UL frame alignment and wait | 14 | 84 | 14 |
| | TTI for BSR transmission | 14 | 14 | 14 |
| | BS processing delay | 4 | 5 | 4 |
| Grant | BS processing delay | 4 | 5 | 5 |
| Transmission | Add BS processing delay | 7 | 14 | 14 |
| | (0.5 ms) | | | |
| | Frame alignment with slot | 13 | 4 | 1 |
| | Wait for slot | 0 | 0 | 14 |
| | DL fame alignment | 13 | 4 | 15 |
| | TTI for PDCCH transmission | 3 | 3 | 3 |
| | UE processing delay | 5 | 6 | 6 |
| UL data | UE processing delay | 5 | 6 | 6 |
| transmission | Frame alignment with slot | 1 | 13 | 13 |
| | Wait for slot | 0 | 70 | 28 |
| | UL frame alignment and wait | 1 | 83 | 41 |
| | TTI for UL data transmission | 14 | 14 | 14 |
| | BS processing delay | 4 | 5 | 5 |
| BSR to UL data | FDD symbols (15 kHz SCS) | 93 | N/A | 37 |
| transmission | TDD symbols (30 kHz SCS) | N/A | 249 | 109 |

| | | | |
|---|---|---|---|
| Time from BSR to UL data transmission (milliseconds) | 6.603 | 8.964 | 6.551 |

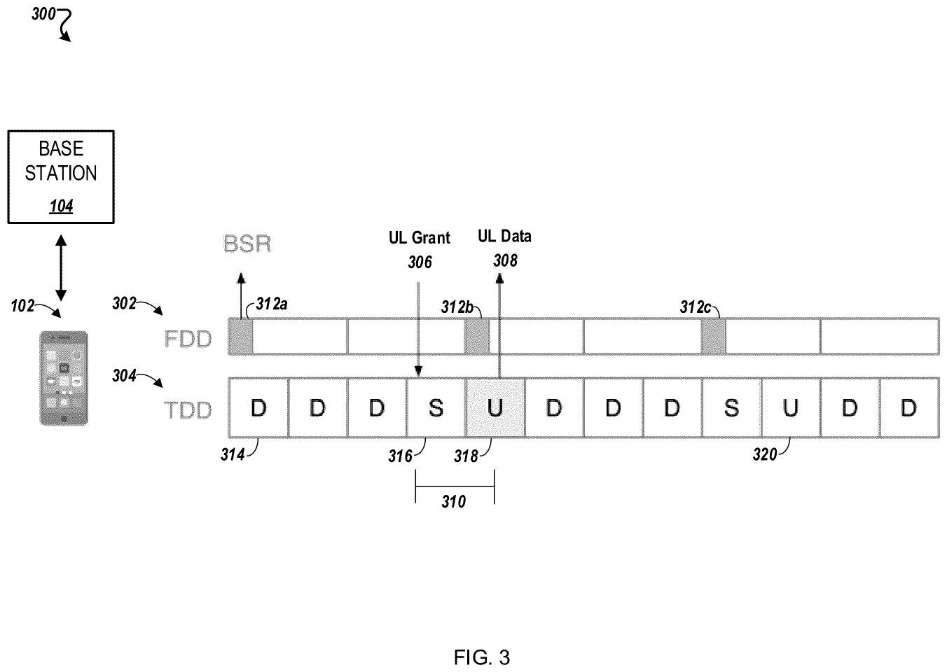

FIG. 3 shows a diagram of a transmission space 300 for a UE (e.g., UE 102 of FIG. 1). The transmission space is similar to transmission space 200, except a mini-slot 312-ac is used for the BSR. Given that the BSR is a very small amount of data, it can be carried in a small PUSCH. If a mini-slot is used for the BSR transmission, a smaller latency 310 can be enabled, relative to a longer latency 210 resulting from a longer slot 212a-c. The mini-slot can be a length of less than 14 symbols (e.g., a two symbol slot), which is about 0.14 ms on an FDD 15 kHz SCS carrier).

The transmission space 300 has an FDD carrier 302 and a TDD carrier 304. The FDD carrier has a configured grant allocated for BSR at instances 312a, 312b, 312c, and so forth. The CG occurs frequently enough that the BSR can be transmitted with the need for a SR transmission from the UE 102. The TDD carrier 304 has slots for downlink 314, labeled “D,” sidelink 316, labeled “S,” and uplink 318, labeled “U.” In the example of the transmission space 300, a UL grant 306 is received at the UE 102 from the network (e.g., a gNB or base station). The UE sends UL data 308 back to the network at the next UL slot. A latency is shown by period 310.

In the example of FIG. 3, if the BSR mini-slot 312b were a normal size (e.g., 1 ms), it would extend past the UL slot 318 of the TDD carrier 304. The latency 310 would extend to slot 320. Generally, when a session with data meeting the criteria specified in Table 2 below are received, the network 104 configures a CG in a mini-slot 312a-c with a relatively frequent occurrence. The CG periodicity and placement is such that the time duration from the CG to the uplink slot 318 on the TDD carrier is enough to schedule an uplink transmission in the uplink slot. For example, the CG (on the FDD carrier 302) may overlap in time the first few symbols of the first ‘D’ slot of a TDD DDDSU configuration carrier 304. Table 2 shows an estimated latency when a 2-symbol PUSCH (e.g., on the FDD carrier 202) is used for BSR transmission. As with Table 1, there are 14 symbols in a slot. A slot in 15 kilohertz (kHz) SCS carrier is 1 ms long and a slot in a 30 kHz SCS carrier is 0.5 ms long. This results in each symbol being 1/14 ms or 1/28 ms, respectively.

TABLE 2
Estimated latency for 2-symbol PUSCH for BSR transmission

| | | Mini-slot BSR on |
|---|---|---|
| | | FDD and UL data |
| | | on TDD Timing |
| | | (Symbols) |
| BSR | UE processing delay | 5 |
| | Frame alignment within slot | 2 |
| | Wait for slot | 0 |
| | UL frame alignment and wait | 2 |
| | TTI for BSR transmission | 2 |
| | BS processing delay | 4 |
| Grant | BS processing delay | 5 |
| Transmission | Additional BS processing delay | 14 |
| | Frame alignment with slot | 1 |
| | Wait for slot | 14 |
| | DL fame alignment | 15 |
| | TTI for PDCCH transmission | 3 |
| | UE processing delay | 6 |
| UL data | UE processing delay | 6 |
| transmission | Frame alignment with slot | 13 |
| | Wait for slot | 28 |
| | UL frame alignment and wait | 41 |
| | TTI for UL data transmission | 14 |
| | BS processing delay | 5 |
| BSR to UL data | FDD symbols (15 kHz SCS) | 13 |
| transmission | TDD symbols (30 kHz SCS) | 109 |

| | |
|---|---|
| Time from BSR to UL data transmission (ms) | 4.847 |

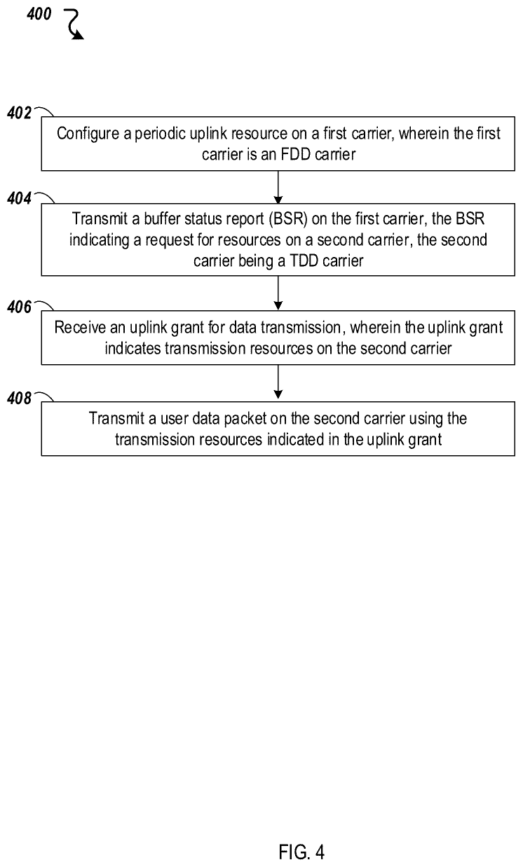

FIG. 4 shows a process 400 for UL latency reduction in FDD-TDD carrier aggregation networks. The process 400 includes a method of transmitting uplink packet. The process 400 includes configuring (402) a periodic uplink resource on a first carrier. In some implementations, the first carrier is an FDD carrier. In some implementations, slots of the FDD carrier are 1 ms long. In some implementations, the FDD carrier has one or more mini-slots. The process 400 includes transmitting (404) a buffer status report (BSR) on the first carrier using the configured UL resource. The buffer status report indicates a request for transmission resources on a second carrier. In some implementations, the second carrier is a TDD carrier. The process 400 includes receiving (406) an uplink (UL) grant for data transmission. In some implementations, the UL grant indicates transmission resources on the second carrier. The process 400 includes transmitting (408) a user data packet on the second carrier using the transmission resources indicated in the UL grant.

In some implementations, the buffer status report on the first carrier indicates a request for resources on a second carrier only if the size of the buffered data is more than a threshold. For example, the threshold for the size of buffered data can be about 20 kilobits (kbits) to 50 kbits, but other values are also possible. In some implementations, the periodic UL resource occurs every other slot for the first carrier. In some implementations, the BSR indicates the request for transmission resources on the second carrier based on a selection of a logical channel group signaled in the BSR. In some implementations, the BSR indicates the request for transmission resources on the second carrier using a reserved LCD. In some implementations, the BSR indicates the request for transmission resources on the second carrier based on a slot of the first carrier for transmitting the BSR. In some implementations, the selection of the second carrier is based on a data type of data stored in the buffer of the UE.

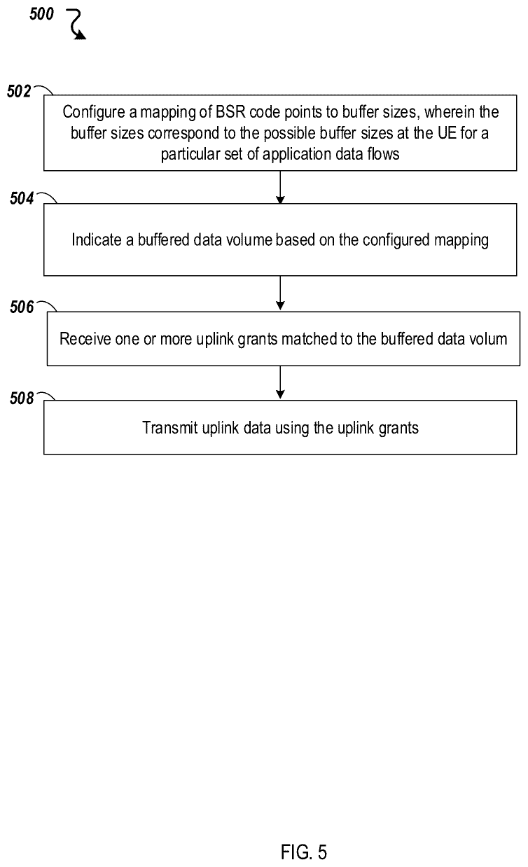

FIG. 5 shows a process 500 for indicating a buffer status of a UE in a FDD-TDD carrier aggregation network. The process 500 includes configuring (502) a mapping of BSR code points to buffer sizes. In some implementations, the buffer sizes correspond to the possible buffer sizes at the UE for a particular set of application data flows. In some implementations, the set of possible buffer sizes are centered on a likely buffer size for a predetermined application. In some implementations, the number of BSR code points is 128.

The process 500 includes indicating (504) a buffered data size based on the configured mapping. The buffer data size depends on the applications configured. For example, the mapping could be such that value 1 corresponds to 10570 bits, value 2 corresponds to 11770 bits, value 3 corresponds to 97221 bits, and value 4 corresponds to 100200 bits. In some implementations, the mapping is customized based on the needs of the application(s) to be used. The process 500 includes receiving (506) one or more uplink grants matched to the buffered data size. The process 500 includes transmitting (508) uplink data using the uplink grants.

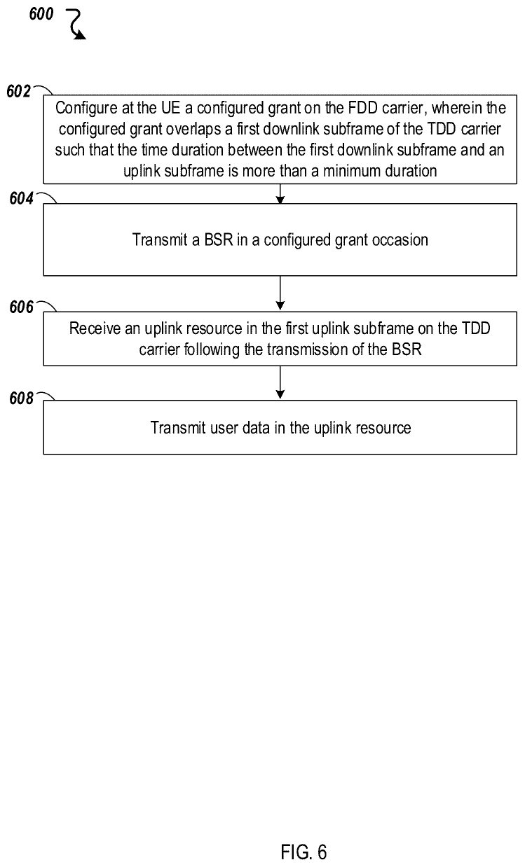

FIG. 6 shows a process 600 for UL latency reduction in FDD-TDD carrier aggregation networks. The process 600 includes configuring (602) at the UE a configured grant on the FDD carrier. In some implementations, the configured grant overlaps a first downlink subframe of the TDD carrier wherein the time duration between the first downlink subframe and an uplink subframe is more than a minimum duration. The process 600 includes transmitting (602) a BSR in a configured grant occasion. The process 600 includes receiving (606) an uplink resource in the first uplink subframe on the TDD carrier following the transmission of the BSR. The process 600 includes transmitting (608) user data in the uplink resource.

The example processes 400, 500, and 600, shown in FIGS. 4,5, and 6, can be modified or reconfigured to include additional, fewer, or different steps (not shown in FIGS. 4, 5, and 6), which can be performed in the order shown or in a different order.

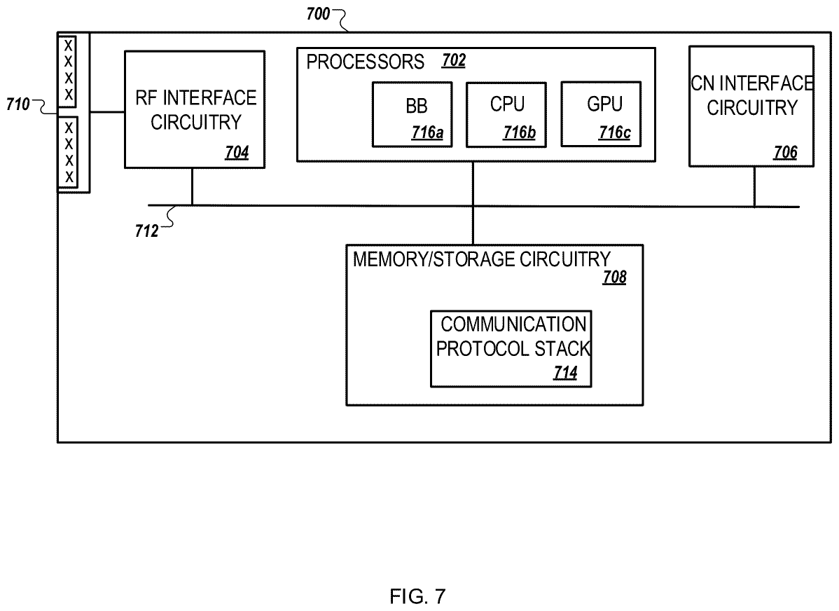

FIG. 7 illustrates an access node 700 (e.g., a base station or gNB), in accordance with some embodiments. The access node 700 may be similar to and substantially interchangeable with base station 104. The access node 700 may include processors 702, RF interface circuitry 704, core network (CN) interface circuitry 706, memory/storage circuitry 708, and antenna structure 710.

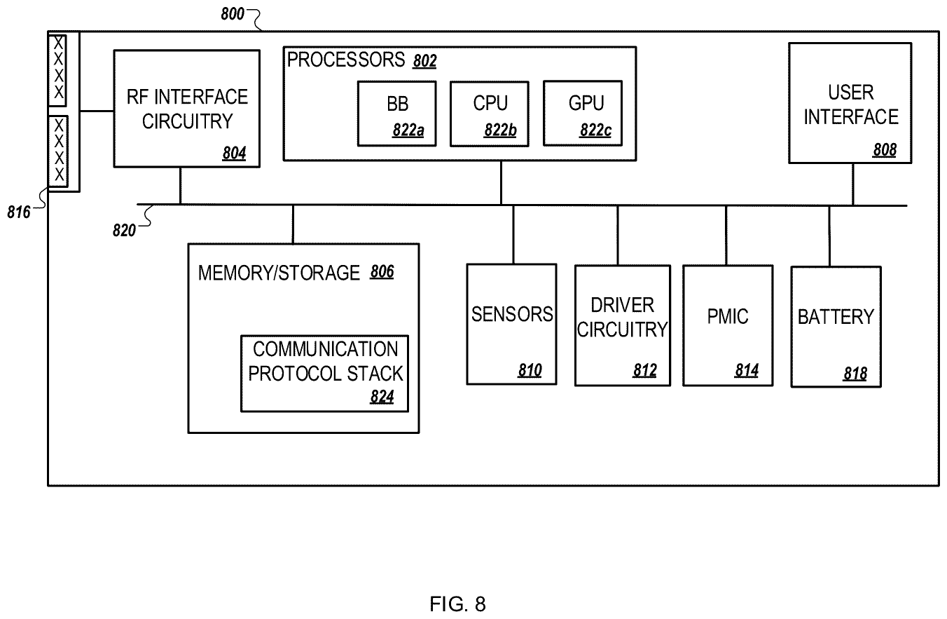

The components of the access node 700 may be coupled with various other components over one or more interconnects 712. The processors 702, RF interface circuitry 704, memory/storage circuitry 708 (including communication protocol stack 714), antenna structure 710, and interconnects 712 may be similar to like-named elements shown and described with respect to FIG. 8. For example, the processors 702 may include processor circuitry such as, for example, baseband processor circuitry (BB) 716A, central processor unit circuitry (CPU) 716B, and graphics processor unit circuitry (GPU) 716C.

The CN interface circuitry 706 may provide connectivity to a core network, for example, a 5th Generation Core network (5GC) using a 5GC-compatible network interface protocol such as carrier Ethernet protocols, or some other suitable protocol. Network connectivity may be provided to/from the access node 700 via a fiber optic or wireless backhaul. The CN interface circuitry 706 may include one or more dedicated processors or FPGAs to communicate using one or more of the aforementioned protocols. In some implementations, the CN interface circuitry 706 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 700 that operates in an NR or 5G system (for example, a gNB), and the term “E-UTRAN node” or the like may refer to an access node 700 that operates in an LTE or 4G system (e.g., an eNB). According to various embodiments, the access node 700 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 700 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 700; a MAC/PHY split wherein RRC, PDCP, RLC, and MAC layers are operated by the CRAN/vBBUP and the PHY layer is operated by the access node 700; or a “lower PHY” split wherein RRC, PDCP, RLC, MAC layers and upper portions of the PHY layer are operated by the CRAN/vBBUP and lower portions of the PHY layer are operated by the access node 700.

In V2X scenarios, the access node 700 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

FIG. 8 illustrates a UE 800, in accordance with some embodiments. The UE 800 may be similar to and substantially interchangeable with UE 102 of FIG. 1. The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 800 may include processors 802, RF interface circuitry 804, memory/storage 806, user interface 808, sensors 810, driver circuitry 812, power management integrated circuit (PMIC) 814, antenna structure 816, and battery 818. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 820, which may represent any type of interface, input/output, bus (local, system, or expansion), transmission line, trace, optical connection, etc. that allows various circuit components (on common or different chips or chipsets) to interact with one another.

The processors 802 may include processor circuitry such as, for example, baseband processor circuitry (BB) 822A, central processor unit circuitry (CPU) 822B, and graphics processor unit circuitry (GPU) 822C. The processors 802 may include any type of circuitry or processor circuitry that executes or otherwise operates computer-executable instructions, such as program code, software modules, or functional processes from memory/storage 806 to cause the UE 800 to perform operations as described herein.

In some embodiments, the baseband processor circuitry 822A may access a communication protocol stack 824 in the memory/storage 806 to communicate over a 3GPP compatible network. In general, the baseband processor circuitry 822A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 804. The baseband processor circuitry 822A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 806 may include one or more non-transitory, computer-readable media that includes instructions (for example, communication protocol stack 824) that may be executed by one or more of the processors 802 to cause the UE 800 to perform various operations described herein. The memory/storage 806 include any type of volatile or non-volatile memory that may be distributed throughout the UE 800. In some embodiments, some of the memory/storage 806 may be located on the processors 802 themselves (for example, L1 and L2 cache), while other memory/storage 806 is external to the processors 802 but accessible thereto via a memory interface. The memory/storage 806 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 804 may include transceiver circuitry and radio frequency front module (RFEM) that allows the UE 800 to communicate with other devices over a radio access network. The RF interface circuitry 804 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 816 and proceed to filter and amplify (with a low-noise amplifier) the signal. The signal may be provided to a receiver of the transceiver that downconverts the RF signal into a baseband signal that is provided to the baseband processor of the processors 802.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 816.

In various embodiments, the RF interface circuitry 804 may be configured to transmit/receive signals in a manner compatible with NR access technologies.

The antenna 816 may include antenna elements to convert electrical signals into radio waves to travel through the air and to convert received radio waves into electrical signals. The antenna elements may be arranged into one or more antenna panels. The antenna 816 may have antenna panels that are omnidirectional, directional, or a combination thereof to enable beamforming and multiple input, multiple output communications. The antenna 816 may include microstrip antennas, printed antennas fabricated on the surface of one or more printed circuit boards, patch antennas, phased array antennas, etc. The antenna 816 may have one or more panels designed for specific frequency bands including bands in FRI or FR2.

The user interface 808 includes various input/output (I/O) devices designed to enable user interaction with the UE 800. The user interface 808 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 800.

The sensors 810 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 812 may include software and hardware elements that operate to control particular devices that are embedded in the UE 800, attached to the UE 800, or otherwise communicatively coupled with the UE 800. The driver circuitry 812 may include individual drivers allowing other components to interact with or control various input/output (I/O) devices that may be present within, or connected to, the UE 800. For example, driver circuitry 812 may include a display driver to control and allow access to a display device, a touchscreen driver to control and allow access to a touchscreen interface, sensor drivers to obtain sensor readings of sensor circuitry 828 and control and allow access to sensor circuitry 828, drivers to obtain actuator positions of electro-mechanic components or control and allow access to the electro-mechanic components, a camera driver to control and allow access to an embedded image capture device, audio drivers to control and allow access to one or more audio devices.

The PMIC 814 may manage power provided to various components of the UE 800. In particular, with respect to the processors 802, the PMIC 814 may control power-source selection, voltage scaling, battery charging, or DC-to-DC conversion.

In some embodiments, the PMIC 814 may control, or otherwise be part of, various power saving mechanisms of the UE 800 including DRX as discussed herein. A battery 818 may power the UE 800, although in some examples the UE 800 may be mounted deployed in a fixed location, and may have a power supply coupled to an electrical grid. The battery 818 may be a lithium ion battery, a metal-air battery, such as a zinc-air battery, an aluminum-air battery, a lithium-air battery, and the like. In some implementations, such as in vehicle-based applications, the battery 818 may be a typical lead-acid automotive battery.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method having operations including configuring a periodic uplink (UL) resource on a first carrier of a user equipment (UE); transmitting a buffer status report (BSR) on the first carrier using the configured UL resource, the buffer status report indicating a request for transmission resources on a second carrier; receiving an UL grant for data transmission on the second carrier, the UL grant indicating transmission resources on the second carrier; and transmitting a user data packet on the second carrier using the transmission resources indicated in the UL grant.

Example 2 may include the method described in example 1, wherein the first carrier is an FDD carrier.

Example 3 may include the method described in any of examples 1-2, wherein the second carrier is a TDD carrier.

Example 4 may include the method described in any of examples 1-3, wherein one or more slots of the first carrier are 1 millisecond (ms) long, and wherein one or more slots of the second carrier are 0.5 ms long.

Example 5 may include the method described in any of examples 1-4, wherein at least one slot for the first carrier is a mini-slot that is smaller than one or more other slots of the first carrier and for carrying the BSR.

Example 6 may include the method described in any of examples 1-5, wherein the first carrier is different than the second carrier.

Example 7 may include the method described in any of examples 1-7, wherein the first carrier uses a smaller bandwidth than the second carrier.

Example 8 may include the method described in any of examples 1-8, wherein the buffer status report on the first carrier indicates a request for resources on a second carrier when a size of buffered data satisfies a threshold size.

Example 9 may include the method described in any of examples 1-9, wherein the periodic UL resource occurs every other slot for the first carrier.

Example 10 may include the method described in any of examples 1-9, wherein the BSR indicates the request for transmission resources on the second carrier based on a selection of a logical channel group signaled in the BSR.

Example 11 may include the method described in any of examples 1-10, wherein the BSR indicates the request for transmission resources on the second carrier using a reserved LCD.

Example 12 may include the method described in any of examples 1-11, wherein the BSR indicates the request for transmission resources on the second carrier based on a slot of the first carrier for transmitting the BSR.

Example 13 includes the method described in any of examples 1-12, wherein a selection of the second carrier is based on a data type of data stored in the buffer of the UE.

Example 14 includes a method having operations including configuring a mapping of each of a plurality of buffer status report (BSR) code points to a corresponding buffer size of a plurality of buffer sizes; indicating a size of buffered data based on the configured mapping; receiving one or more uplink grants matched to the size of buffered data; and transmitting uplink data using the one or more uplink grants.

Example 15 may include the method described in example 14, wherein the buffer sizes correspond to a set of possible buffer sizes at the UE for a particular set of application data flows.

Example 16 may include the method described in any of examples 14-15, wherein the set of possible buffer sizes are centered on a likely buffer size for a predetermined application.

Example 17 may include the method described in any of examples 14-16, wherein a number of the BSR code points is 128.

Example 18 includes a method having operations including configuring, at a user equipment (UE) a configured grant on a FDD carrier of the UE; transmitting a buffer status report (BSR) using an instance of the configured grant; based on transmitting the BSR, receiving an uplink (UL) resource in a first uplink subframe on a TDD carrier; and transmitting user data in the UL resource.

Example 19 may include the method described in example 18, wherein the configured grant overlaps a first downlink (DL) subframe of the TDD carrier.

Example 20 may include the method described in any of examples 18-19, wherein a time duration between a first downlink subframe and a subsequent uplink subframe exceeds a minimum duration.

Example 21 may include a user equipment comprising one or more processors configured to perform the method of any of examples 1 to 20.

Example 22 may include one or more non-transitory computer-readable media including instructions to cause an electronic device, upon execution of the instructions by one or more processors of the electronic device, to perform one or more elements of a method described in or related to any of examples 1-20, or any other method or process described herein.

Example 23 may include an apparatus including logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus including: one or more processors and one or more computer-readable media including instructions that, when executed by the one or more processors, cause the one or more processors to perform the method, techniques, or process as described in or related to any of examples 1-20, or portions thereof.

Example 26 may include a signal as described in or related to any of examples 1-20, or portions or parts thereof.

Example 27 may include a datagram, information element, packet, frame, segment, PDU, or message as described in or related to any of examples 1-20, or portions or parts thereof, or otherwise described in the present disclosure.

Example 28 may include a signal encoded with data as described in or related to any of examples 1-23, or portions or parts thereof, or otherwise described in the present disclosure.

Example 29 may include a signal encoded with a datagram, IE, packet, frame, segment, PDU, or message as described in or related to any of examples 1-20, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program including instructions, wherein execution of the program by a processing element is to cause the processing element to carry out the method, techniques, or process as described in or related to any of examples 1-20, or portions thereof. The operations or actions performed by the instructions executed by the processing element can include the methods of any one of examples 1-20.

Example 32 may include a signal in a wireless network as shown and described herein.

Example 33 may include a method of communicating in a wireless network as shown and described herein.

Example 34 may include a system for providing wireless communication as shown and described herein. The operations or actions performed by the system can include the methods of any one of examples 1-20.

Example 35 may include a device for providing wireless communication as shown and described herein. The operations or actions performed by the device can include the methods of any one of examples 1-20.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method for indicating a buffer status of a user equipment in a carrier aggregation network, the method comprising:
configuring a mapping of each of a plurality of buffer status report (BSR) code points to a corresponding buffer size of a plurality of buffer sizes;
indicating a size of buffered data based on the configured mapping;
receiving one or more uplink grants matched to the size of buffered data; and
transmitting uplink data using the one or more uplink grants.

2. The method of claim 1, wherein the buffer sizes correspond to a set of possible buffer sizes at a user equipment for a particular set of application data flows.

3. The method of claim 2, wherein the set of possible buffer sizes are centered on a likely buffer size for a predetermined application.

4. The method of claim 1, wherein a number of the BSR code points is 128.

5. The method of claim 1, wherein the BSR indicates a request for transmission resources on a carrier based on a selection of a logical channel group signaled in the BSR.

6. The method of claim 1, wherein the BSR indicates a request for transmission resources on a carrier using a reserved logical cell identifier.

7. The method of claim 1, wherein the BSR indicates a request for transmission resources on a first carrier based on a slot of a second carrier for transmitting the BSR.

8. The method of claim 1, wherein a selection of a carrier is based on a data type of data stored in a buffer of a user equipment.

9. A method for uplink latency reduction in a carrier aggregation network, the method comprising:
configuring, at a user equipment (UE) a configured grant on a frequency division duplex (FDD) carrier of the UE;
transmitting a buffer status report (BSR) using an instance of the configured grant;
based on transmitting the BSR, receiving an uplink (UL) resource in a first uplink subframe on a time division duplex (TDD) carrier; and
transmitting user data in the UL resource.

10. The method of claim 9, wherein the configured grant overlaps a first downlink (DL) subframe of the TDD carrier.

11. The method of claim 9, wherein a time duration between a first downlink subframe and a subsequent uplink subframe exceeds a minimum duration

12. The method of claim 9, wherein buffer sizes correspond to a set of possible buffer sizes at the UE for a particular set of application data flows.

13. The method of claim 12, wherein the set of possible buffer sizes are centered on a likely buffer size for a predetermined application.

14. The method of claim 9, wherein the BSR indicates a request for transmission resources on a carrier based on a selection of a logical channel group signaled in the BSR.

15. The method of claim 9, wherein the BSR indicates a request for transmission resources on a carrier using a reserved logical cell identifier.

16. An apparatus comprising one or more baseband processors configured to perform operations comprising:
configuring a mapping of each of a plurality of buffer status report (BSR) code points to a corresponding buffer size of a plurality of buffer sizes;
indicating a size of buffered data based on the configured mapping;
receiving one or more uplink grants matched to the size of buffered data; and
transmitting uplink data using the one or more uplink grants.

17. The apparatus of claim 16, wherein the buffer sizes correspond to a set of possible buffer sizes at a user equipment for a particular set of application data flows.

18. The apparatus of claim 17, wherein the set of possible buffer sizes are centered on a likely buffer size for a predetermined application.

19. The apparatus of claim 16, wherein a number of the BSR code points is 128.

20. The apparatus of claim 16, wherein the BSR indicates a request for transmission resources on a carrier based on a selection of a logical channel group signaled in the BSR.
